(19) United States
(12) Patent Application Publication
(10) Pub. No.: US 2026/0101345 A1
(43) Pub. Date: Apr. 9, 2026

(54) HANDLING TIME OVERLAPPED UL TRANSMISSIONS

(71) Applicant: TELEFONAKTIEBOLAGET LM ERICSSON (PUBL), Stockholm (SE)

(72) Inventors: Shiwei Gao, Nepean, Ontario (CA); Andreas Nilsson, Göteborg (SE); Siva Muruganathan, Stittsville, Ontario, CA (US)

(21) Appl. No.: 19/114,938

(22) PCT Filed: Sep. 29, 2023
(86) PCT No.: PCT/IB2023/059800

§ 371 Date: Mar. 25, 2025

Related U.S. Application Data
(60) Provisional application No. 63/412,037, filed on Sep. 30, 2022.

(51) Int. Cl. H04W 72/21; H04W 76/38

(52) U.S. Cl. CPC H04W 72/21; H04W 76/38

(57) ABSTRACT

Systems and methods are disclosed that relate to handling of time-overlapped uplink transmissions in a cellular communications system. In one embodiment, a method performed by a user equipment (UE) comprises receiving a first timing advance and a second timing advance, receiving a request for a first uplink transmission according to the first timing advance, and receiving a request for a second uplink transmission according to the second timing advance, wherein the first uplink transmission and the second uplink transmission at least partially overlap in time. The method further comprises dropping at least part of the first uplink transmission or at least part of the second uplink transmission. In this manner, the possibility of collision of uplink transmissions (e.g., to multiple Transmission and Reception Points (TRPs)) may be reduced and thus the uplink resource utilization may be improved.

### RELATED APPLICATIONS

This application claims the benefit of provisional patent application Ser. No. 63/412,037, filed Sep. 30,/2022, the disclosure of which is hereby incorporated herein by reference in its entirety.

### TECHNICAL FIELD

The present disclosure relates to a cellular communications system and, more specifically, to handling of time overlapping uplink transmissions scheduled for transmission from a User Equipment (UE) to multiple Transmission and Reception Points (TRPs).

### BACKGROUND

Third Generation Partnership Project (3GPP) New Radio (NR) uses Cyclic Prefix Orthogonal Frequency Division Multiplexing (CP-OFDM) in both downlink (DL) (i.e. from a network node, gNB, or base station, to a user equipment or UE) and uplink (UL) (i.e. from UE to gNB). Discrete Fourier Transform (DFT) spread Orthogonal Frequency Division Multiplexing (OFDM) is also supported in the uplink. In the time domain, NR downlink and uplink are organized into equally sized subframes of 1 millisecond (ms) each. A subframe is further divided into multiple slots of equal duration. The slot length depends on subcarrier spacing. For subcarrier spacing of Δf=15 kilohertz (kHz), there is only one slot per subframe, and each slot consists of 14 OFDM symbols.

Data scheduling in NR is typically in slot basis, an example is shown in FIG. 1 with a 14-symbol slot, where the first two symbols contain Physical Downlink Control Channel (PDCCH) and the rest of the symbols contain physical shared data channel, either Physical Downlink Shared Channel (PDSCH) or Physical Uplink Shared Channel (PUSCH). In other words, FIG. 1 illustrates an exemplary NR time-domain structure with 15 kHz subcarrier spacing.

Different subcarrier spacing (SCS) values are supported in NR. The supported SCS values (also referred to as different numerologies) are given by Δf=(15×2\hat{ }μ) kHz where u └{0,1,2,3,4}. Δf=15 kHz is the basic subcarrier spacing. The slot duration for a given subcarrier spacing is ½\hat{ }μ ms.

In the frequency domain, a system bandwidth is divided into Resource Blocks (RBs), each corresponds to 12 contiguous subcarriers. The RBs are numbered starting with 0 from one end of the system bandwidth. The basic NR physical time-frequency resource grid is illustrated in FIG. 2, where only one RB within a 14-symbol slot is shown. One OFDM subcarrier during one OFDM symbol interval forms one Resource Element (RE).

Downlink transmissions to a User Equipment (UE) can be dynamically scheduled by sending Downlink Control Information (DCI) with a downlink (DL) DCI format on PDCCH. The DCI contains scheduling information such as time and frequency resource, modulation and coding scheme, etc. The user data is carried on PDSCH. The UE first detects and decodes PDCCH and, if the decoding is successful, the UE then decodes the corresponding PDSCH according to the scheduling information in the DCI.

Similarly, uplink data transmission can be dynamically scheduled using an uplink (UL) DCI format on PDCCH. A UE first decodes an uplink grant in the DCI and then transmits data over PUSCH according to the control information contained in the uplink grant such as modulation order, coding rate, uplink resource allocation, etc.

In addition to dynamic scheduling, semi-persistent transmission of PUSCH using Configured Grants (CGs) is also supported in NR. There are two types of CG based PUSCH defined in NR starting with Release 15. In CG type 1, a periodicity of PUSCH transmission as well as the time domain offset are configured by Radio Resource Control (RRC). In CG type 2, a periodicity of PUSCH transmission is configured by RRC and then the activation and release of such transmission is controlled by DCI, i.e., with a PDCCH.

### UL Time Alignment

Different UEs in a cell may typically be located at different positions within the cell and then within different distances from the base station (e.g., NR gNodeB (gNB)). As the UEs may be at different locations relative to the gNB, if all UEs transmit to the gNB at same time instance, transmissions from different UEs may reach the gNB at different instances. Unless all UE transmissions are received at the gNB at the same time or within a certain reception window, they will interfere with each other and thereby result in demodulation difficulties at the gNB. In order to make sure that the UL transmissions from a UE reaches the base station within the corresponding reception window in the base station, an uplink timing control procedure is therefore used.

Time alignment of the uplink transmissions is achieved by applying a timing advance at the UE transmitter, relative to the received downlink timing. The main role of this is to counteract different propagation delays between different UEs, as shown in the example of FIG. 3 for an NR gNB. FIG. 3 illustrates an exemplary time alignment of uplink transmissions for a case (a) without timing advance and for a case (b) with timing advance.

In order to achieve the time alignment between different UEs, the base station (e.g., gNB, or eNodeB (eNB) in the case of Long Term Evolution (LTE)) derives the Timing Advance (TA) value that the UE needs to use for UL transmissions in order for the UL transmissions to reach the base station within the receive window and indicates this TA value to the UE.

When the UE first accesses a cell, the UE uses the random-access procedure where the UE transmits a Physical Random Access Channel (PRACH) preamble (Msg1 for 4-step Random Access Channel (RACH) or MsgA for 2-step RACH) to the base station, and the Msg1 or Msg A is used by the base station to determine the UE's initial TA to use for UL transmissions in the cell.

The base station derived timing advance or timing correction is sent from the base station to the UE in a RACH response or Random Access Response (RAR) message for the UE.

A UE in NR typically acquires initial downlink (DL) slot and symbol timing (DL timing in short) based on an SSB (Synchronization Signals and Physical Broadcast Channel Block) and initial UL timing based on a random access (RACH) procedure, in which the UE transmits a PRACH preamble in a PRACH resource associated with the SSB using the DL timing as a reference. A timing correction is then sent from the base station to the UE in a RAR. The timing correction is referred to as a timing advance (TA), which is used to correct the UE UL transmission timing such that the subsequent UL channels or signals can reach the base station at the desired UL slot or symbol time.

An example is shown in FIG. 4, where the one-way propagation delay between the base station and the UE is t. To achieve UL time alignment, a timing advance of N_{TA}=2τ is needed at the UE with respect to the acquired DL timing in order to compensate for the propagation delay.

In some scenarios, the UL and DL slot timing may be shifted intentionally by a configurable time offset, N_{TA,offset}. In that case, N_{TA} is applied in addition to the fixed timing advance offset N_{TA,offset}, i.e., the total applied timing advance is N_{TA,offset}+N_{TA}.

In Carrier Aggregation (CA), a UE may be configured with multiple serving cells, where some of the serving cells may not be co-located and different TAs may be needed for UL transmissions to those cells. To inform the UE about such a scenario, the concept of a Timing Advance Group (TAG) was introduced. For cells that are co-located and can share a same TA value, these cells belong to a same TAG and can be configured with a same TAG identifier or index (ID). For cells that are not co-located and need different TAs, such cells can be configured in different TAGs.

After the UE is configured with its serving cell(s) for a given cell group (e.g., Master Cell Group—MCG and/or Secondary Cell Group-SCG), the UE obtains the initial TA value via the RAR, and the UE is configured with the association between serving cells and TAG identifiers, the UE needs to maintain the time alignment according to the TA procedure defined in Clause 5.2 in 3GPP TS 38.321 (see, e.g., V17.1.0).

Except initial TA, regular TAs during time maintenance are carried in a timing advance command Medium Access Control (MAC) Control Element (CE) containing a TAG Identity (TAG ID) and a Timing Advance Command according to 3GPP TS 38.213 (see, e.g., V17.1.0). Upon reception of a timing advance command for a TAG, the UE adjusts uplink timing for PUSCH/Sounding Reference Signal (SRS)/Physical Uplink Control Channel (PUCCH) transmission on all the serving cells in the TAG based on a value that the UE expects to be same for all the serving cells in the TAG and based on the received timing advance command where the uplink timing for PUSCH/SRS/PUCCH transmissions is the same for all the serving cells in the TAG.

For time alignment maintenance purpose, a time alignment timer per TAG is used to control how long the MAC entity considers the Serving Cells belonging to the associated TAG to be uplink time aligned. The time alignment timer thus indicates a time duration within which the UE may consider a received TA value as valid. If the UE does not receive an updated value before the time alignment timer expires, the UE is no longer UL synchronized to the serving cells belonging to the corresponding TAG.

### Timing Advance Group (TAG):

In CA, a UE may be configured with multiple serving cells, and UE may experience same or different propagation delay to these cells. If the propagation delay to some of the cells is same or within a certain range, the network may configure a single TA maintenance procedure to these cells to save signalling overhead. The group of cells configured with a single TA maintenance procedure are said to belong to same TAG. To understand this better, consider the following example for illustration. If a UE is connected to 6 cells, in one scenario, three cells may have same TA (TA1) or TAs within a certain range (TA1+delta1) and three other cells may have same TA (TA2) or TAs within a certain range (TA2+delta2). The three cells whose TAs are TA1 can be mapped to TAG1, and the three other cells whose TAs are TA2 can be mapped to TAG2.

Application of TA at the UE per TAG:

According to 3GPP TS 38.213, upon reception of a timing advance command for a TAG, the UE adjusts uplink timing (N_{TA}⋅) with respect to downlink timing for PUSCH/SRS/PUCCH transmission on all the serving cells in the TAG based on the following equation:

$${N}_{{TA}^{′}} = ( {N}_{TA} + {N}_{TA , offset} ) * 0.509 nanoseconds ( ns )$$

$$where ,$$

$${N}_{TA} = {N}_{TA \_ old} + ( TA - 31 ) * 16 * 64 / ( 2 μ ) for timing maintenance ( i . e . , TA is obtained through MAC CE ) .$$

$${N}_{TA} = TA * 16 * 64 / ( 2 μ ) for initial timing using RACH procedure ( i . e . , TA is obtained through RAR )$$

where the value N_{TA,offset} is specified as per Table 1 below.

TABLE 1
The value of N_{TA, offset} from TS 38.133

| Frequency range and band of cell | N_{TA offset} |
|---|---|
| used for uplink transmission | (Unit: T_{C}) |
| FR1 FDD or TDD band with | 25600 |
| neither E-UTRA-NR nor NB- | (Note 1) |
| IoT-NR coexistence case | |
| FR1 FDD band with E-UTRA-NR | 0 |
| and/or NB-IoT-NR | (Note 1) |
| coexistence case | |
| FR1 TDD band with E-UTRA-NR | 39936 |
| and/or NB-IoT-NR | (Note 1) |
| coexistence case | |
| FR2 | 13792 |

(Note 1):
The UE identifies N_{TA offset} based on the information n-TimingAdvanceOffset as specified in TS 38.331 [2]. If UE is not provided with the information n-TimingAdvanceOffset, the default value of N_{TA offset} is set as 25600 for FR1 band. In case of multiple UL carriers in the same TAG, UE expects that the same value of n-TimingAdvanceOffset is provided for all the UL carriers according to clause 4.2 in TS 38.213 [3] and the value 39936 of N_{TA offset} can also be provided for a FDD serving cell.
Note 2:
Void

### TA Maintenance Procedure:

When the UE does not perform any UL transmissions for some time in a serving cell or due to UE mobility or timing clock shift at UE, the TA value that the UE used earlier may no longer be accurate. To avoid UE using an invalid TA, a timer called timeAlignmentTimer is configured for each TAG to indicate how long the UE can consider itself to be uplink time aligned to serving cells belonging to the associated TAG, without receiving any updates to the TA value. In other words, the timeAlignmentTimer indicates a time duration within which the UE may consider the received TA value as valid. If the UE does not receive an updated value before timeAlignmentTimer expires, the UE is no longer UL synchronized to the serving cells belonging to the corresponding TAG. The details are described in section 9.2.9 of 3GPP TS 38.300 (see, e.g., V17.1.0). Upon expiry of TimeAlignmentTimer, the UE shall not transmit any UL transmissions to the serving cells belonging to the TAG whose timer is expired, and the UE should send a PRACH to the serving cells belonging to the TAG whose timer is expired.

### Multi-DCI Scheduling

In NR Release 16, multi-DCI based DL and UL scheduling was introduced in 3GPP specifications, in which a UE may receive two DCI formats, a first and a second DCI formats, carried by two PDCCHs, a first and a second PDCCHs, in two Control Resource Sets (CORESETs), a first and a second CORESETs, respectively, in a slot. The first and second CORESETs are associated with a first and a second CORESET pool indices. The first and second DCI formats schedule first and a second PDSCHs transmitted from first and second Transmission and Reception Points (TRPs), respectively. The two TRPs can belong to a same serving cell or different cells. It is assumed that the time difference between the two TRPs are very small and within the cyclic prefix (CP) so that a common DL and UL timing is used for both TRPs.

An example is shown in FIG. 5, where PDCCH 1 in CORESET 1 with CORESET pool index=0 schedules PDSCH1 from TRP1 while PDCCH 2 in CORESET 2 with CORESET pool index=1 schedules PDSCH2 from TRP2. The two PDSCHs may be fully, partially, or non-overlapping in time. The Hybrid Automatic Repeat Request (HARQ)-Acknowledgements (ACKs) associated with PDSCH1 and PDSCH2 are carried in PUCCH1 and PUCCH2, respectively, which are non-overlapping in time and are transmitted towards TRP1 and TRP2, respectively.

Similarly, a PUSCH towards TRP1 can be scheduled by a DCI format carried in a PDCCH in CORESET 1 and a PUSCH towards TRP2 can be scheduled by a DCI format carried in a PDCCH in CORESET 2. An example of multi-DCI based PUSCH scheduling from two TRPs is shown in FIG. 6, where PDCCH 3 in CORESET 1 with CORESET pool index=0 schedules PUSCH1 to TRP1 while PDCCH 4 in CORESET 2 with CORESET pool index=1 schedules PUSCH2 to TRP2. In NR Rel-16, PUSCH1 and PUSCH2 are non-overlapping in time.

For multi-DCI multi-TRP operation, a UE needs to be configured with two CORESET pools, each associated with a TRP. Each CORESET pool is a collection of CORESETs configured with a same CORESET pool index.

### SUMMARY

Systems and methods are disclosed that relate to handling of time-overlapped uplink transmissions in a cellular communications system. In one embodiment, a method performed by a user equipment (UE) comprises receiving a first timing advance and a second timing advance, receiving a request for a first uplink transmission according to the first timing advance, and receiving a request for a second uplink transmission according to the second timing advance, wherein the first uplink transmission and the second uplink transmission at least partially overlap in time. The method further comprises dropping at least part of the first uplink transmission or at least part of the second uplink transmission. In this manner, the possibility of collision of uplink transmissions (e.g., to multiple Transmission and Reception Points (TRPs)) may be reduced and thus the uplink resource utilization may be improved.

In one embodiment, the first uplink transmission and the second uplink transmission are part of a multi-TRP uplink transmission. In one embodiment, the request for the first uplink transmission is a first Downlink Control Information (DCI) carried by a first Physical Downlink Control Channel (PDCCH) in a first Control Resource Set (CORESET), and the request for the second uplink transmission is a second DCI carried by a second PDCCH in a second CORESET. In one embodiment, the first CORESET is associated to a first CORESET pool index value and the second CORESET is associated to a second CORESET pool index value, wherein the first and the second CORESET pool index values are different.

In one embodiment, the first timing advance is associated to a first Timing Advance Group (TAG), and the second timing advance is associated to a second TAG.

In one embodiment, the first uplink transmission is in a first time slot, and the second transmission is in a second time slot that is adjacent in time to the first time slot. In one embodiment, the first uplink transmission and the second uplink transmission at least partially overlap in time as a result of the first timing advance and the second timing advance. In one embodiment, the first timing advance is different than the second timing advance.

In one embodiment, dropping at least part of the first uplink transmission or at least part of the second uplink transmission comprises dropping part of one of the first uplink transmission and the second uplink transmission that starts later in time. In one embodiment, the part of the one of the first uplink transmission and the second uplink transmission that starts later in time that is dropped is a part that corresponds to an overlap between the first uplink transmission and the second uplink transmission.

In one embodiment, dropping at least part of the first uplink transmission or at least part of the second uplink transmission comprises either dropping part of one of the first uplink transmission and the second uplink transmission that starts later in time or part of one of the first uplink transmission and the second uplink transmission that starts earlier in time, wherein the UE alternates between slots whether the UE drops an uplink transmission that starts later in time or drops an uplink transmission that starts earlier in time during a time duration that corresponds to an overlap.

In one embodiment, a time duration of an overlap between the first uplink transmission and the second uplink transmission is divided into a first part and a second part, and dropping (1206) at least part of the first uplink transmission or at least part of the second uplink transmission comprises dropping part of the first uplink transmission during the first part of the overlap and dropping a part of the second uplink transmission during the second part of the overlap.

In one embodiment, different uplink channels or signals are assigned different priority levels, the first uplink transmission comprises a first uplink channel or signal during a time duration of an overlap between the first uplink transmission and the second uplink transmission, the second uplink transmission comprises a second uplink channel or signal during the time duration of the overlap between the first uplink transmission and the second uplink transmission, and dropping at least part of the first uplink transmission or at least part of the second uplink transmission comprises dropping, during the time duration of the overlap, one of the first uplink channel or signal carried by the first uplink transmission and the second uplink channel or signal carried by the second uplink transmission having a lower priority level.

In one embodiment, the first uplink transmission is to a first TRP and the second uplink transmission is to a second TRP, uplink transmissions to the first TRP are assigned a first priority level and uplink transmissions to the second TRP are assigned a second priority level, and dropping at least part of the first uplink transmission or at least part of the second uplink transmission comprises dropping at least part of one of the first uplink transmission and the second uplink transmission having a lower priority level.

In one embodiment, the first and second uplink transmissions are one or more of: a Physical Uplink Shared Channel (PUSCH) transmission, a Physical Uplink Control Channel, (PUCCH) transmission, and a Sounding Reference Signal (SRS) transmission.

Corresponding embodiments of a UE are also disclosed. In one embodiment, a UE is adapted to receive a first timing advance and a second timing advance, receive a request for a first uplink transmission according to the first timing advance, receive a request for a second uplink transmission according to the second timing advance, wherein the first uplink transmission and the second uplink transmission at least partially overlap in time, and drop at least part of the first uplink transmission or at least part of the second uplink transmission.

In one embodiment, a UE comprises a communication interface and processing circuitry associated with the communication interface. The processing circuitry is configured to cause the UE to receive a first timing advance and a second timing advance, receive a request for a first uplink transmission according to the first timing advance, receive a request for a second uplink transmission according to the second timing advance, wherein the first uplink transmission and the second uplink transmission at least partially overlap in time, and drop at least part of the first uplink transmission or at least part of the second uplink transmission.

In another embodiment, a method performed by a UE comprises receiving a first timing advance and a second timing advance and reporting, to a network node, a timing difference between uplink transmissions that use the first timing advance and uplink transmissions that use the second timing advance.

In one embodiment, the first timing advance is for uplink transmissions scheduled by a first DCIs in a first CORESET(s) to a first TRP, and the second timing advance is for uplink transmissions scheduled by a second DCIs in a second CORESET(s) to a second TRP, wherein the first CORESET(s) is associated to a first CORESET pool index value and the second CORESET(s) is associated to a second CORESET pool index value, wherein the first and the second CORESET pool index values are different.

In one embodiment, the uplink transmissions are one or more of: a PUSCH transmission, a PUCCH transmission, and an SRS transmission.

Corresponding embodiments of a UE are also disclosed. In one embodiment, a UE is adapted to receive a first timing advance and a second timing advance and report, to a network node, a timing difference between uplink transmissions that use the first timing advance and uplink transmissions that use the second timing advance.

In one embodiment, a UE comprises a communication interface and processing circuitry associated with the communication interface. The processing circuitry is configured to cause the UE to receive a first timing advance and a second timing advance and report, to a network node, a timing difference between uplink transmissions that use the first timing advance and uplink transmissions that use the second timing advance.

In another embodiment, a method performed by network node for scheduling a first uplink transmission from a UE to a first TRP with a first timing advance in a first time slot and a second uplink transmission to a second TRP with a second timing advance in a second time slot, wherein the first and the second slots are adjacent slots, comprises determining an overlap in time between the first and second uplink transmissions by assuming that each of the first and second transmission were scheduled in a full slot and performing uplink scheduling by adjusting a start and/or length of at least one of the first and second uplink transmissions such that the overlap, in time, between the first and second uplink transmissions from the UE is avoided.

In one embodiment, performing uplink scheduling comprises refraining to schedule an uplink transmission from the UE to one of the first and second TRPs in a time duration in which the uplink transmission from the UE to the one of the first and second TRPs would overlap an uplink transmission scheduled from the UE to the other of the first and second TRPs.

In one embodiment, the determining further comprises receiving, from the UE, a ΔT value that indicates an amount of time that an uplink transmission from the UE to the first TRP using the first timing advance in the first time slot would overlap an uplink transmission from the UE to the second TRP using the second timing advance in the second time slot that is adjacent, in time, to the first time slot.

In one embodiment, the determining further comprises receiving the first timing advance from the first TRP and/or receiving the second timing advance from the second TRP.

In one embodiment, the uplink transmissions from the UE to the first TRP is scheduled by a first DCIs in a first CORESET(s) and the uplink transmissions from the UE to the second TRP is scheduled by a second DCIs in a second CORESET(s), wherein the first CORESET(s) is associated to a first CORESET pool index value and the second CORESET(s) is associated to a second CORESET pool index value, wherein the first and the second CORESET pool index values are different.

In one embodiment, the first timing advance is associated to a first Timing Advance Group (TAG), and the second timing advance is associated to a second TAG.

Corresponding embodiments of a network node are also disclosed. In one embodiment, a network node for scheduling a first uplink transmission from UE to a first TRP with a first timing advance in a first time slot and a second uplink transmission to a second TRP with a second timing advance in a second time slot, wherein the first and the second slots are adjacent slots, is adapted to determine an overlap in time between the first and second uplink transmissions by assuming that each of the first and second transmission were scheduled in a full slot and perform uplink scheduling by adjusting a start and/or length of at least one of the first and second uplink transmissions such that the overlap, in time, between the first and second uplink transmissions from the UE is avoided.

In one embodiment, a network node for scheduling a first uplink transmission from UE to a first TRP with a first timing advance in a first time slot and a second uplink transmission to a second TRP with a second timing advance in a second time slot, wherein the first and the second slots are adjacent slots, comprises processing circuitry configured to cause the network node to determine an overlap in time between the first and second uplink transmissions by assuming that each of the first and second transmission were scheduled in a full slot and perform uplink scheduling by adjusting a start and/or length of at least one of the first and second uplink transmissions such that the overlap, in time, between the first and second uplink transmissions from the UE is avoided.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the New Radio (NR) time-domain structure with 15 kilohertz (kHz) subcarrier spacing;

FIG. 2 illustrates the NR physical resource grid;

FIG. 3 illustrates time alignment of uplink transmissions for a case (a) without timing advance and for a case (b) with timing advance;

FIG. 4 illustrates time alignment of uplink transmissions with a timing advance;

FIG. 5 illustrates an example of multi-Downlink Control Information (DCI) based Physical Downlink Shared Channel (PDSCH) scheduling from two Transmission and Reception Points (TRPs);

FIG. 6 illustrates an example of multi-DCI based Physical Uplink Shared Channel (PUSCH) scheduling from two TRPs;

FIG. 7 illustrates an example illustrating possible time overlap of uplink transmissions to different TRPs;

FIG. 8 illustrates an example of uplink transmissions to two TRPs with two different timing advances where there is a time overlap of the uplink transmissions;

FIG. 9 illustrates an example of uplink transmission restricted towards one of the TRPs during the overlapping duration ΔT, in accordance with an embodiment of the present disclosure;

FIG. 10 illustrates an example of uplink transmission restricted towards different TRPs during the overlapping duration ΔT in alternating slots, in accordance with an embodiment of the present disclosure;

FIG. 11 illustrates an example of a User Equipment (UE) dropping uplink transmission towards different TRPs during the overlapping duration ΔT in alternating slots, in accordance with an embodiment of the present disclosure;

FIG. 12 illustrates a method performed by a UE according to some embodiments of the disclosure;

FIG. 13 illustrates a method performed by a network node according to some embodiments of the disclosure;

FIG. 14 shows an example of a communication system in accordance with some embodiments;

FIG. 15 shows a UE in accordance with some embodiments;

FIG. 16 shows a network node in accordance with some embodiments;

FIG. 17 is a block diagram of a host, which may be an embodiment of the host of FIG. 14, in accordance with various aspects described herein;

FIG. 18 is a block diagram illustrating a virtualization environment in which functions implemented by some embodiments may be virtualized; and

FIG. 19 shows a communication diagram of a host communicating via a network node with a UE over a partially wireless connection in accordance with some embodiments.

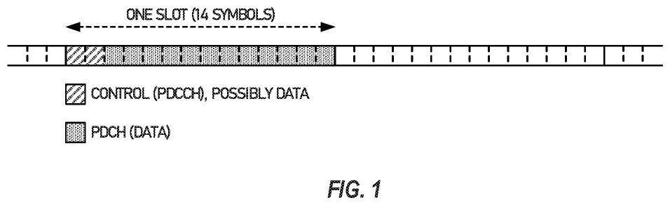

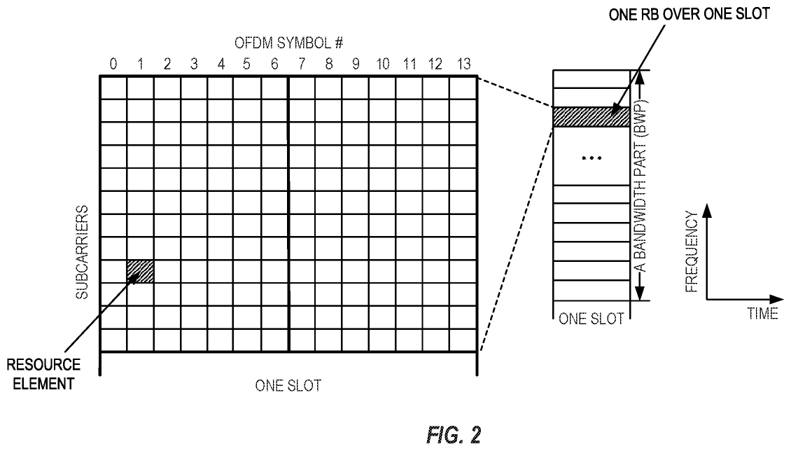

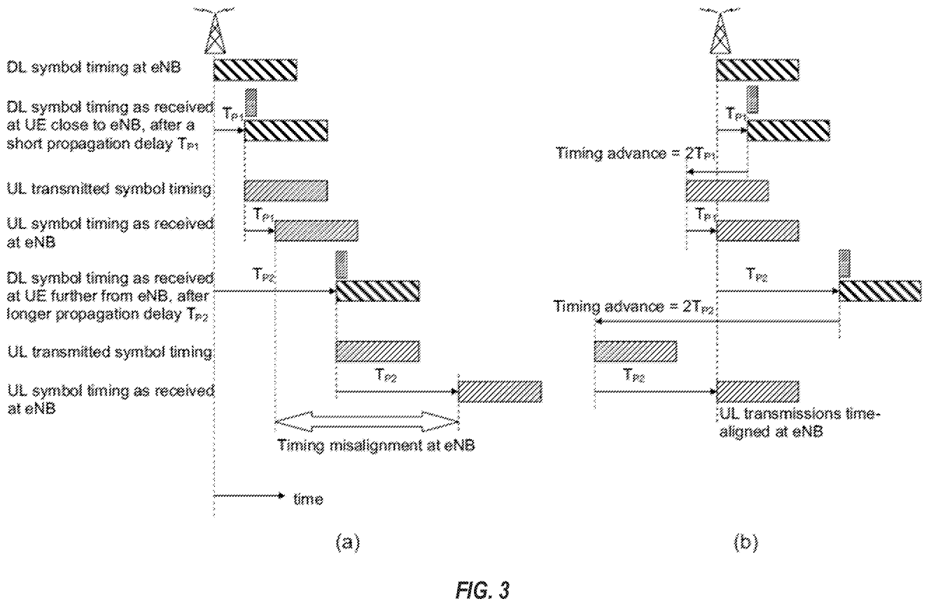

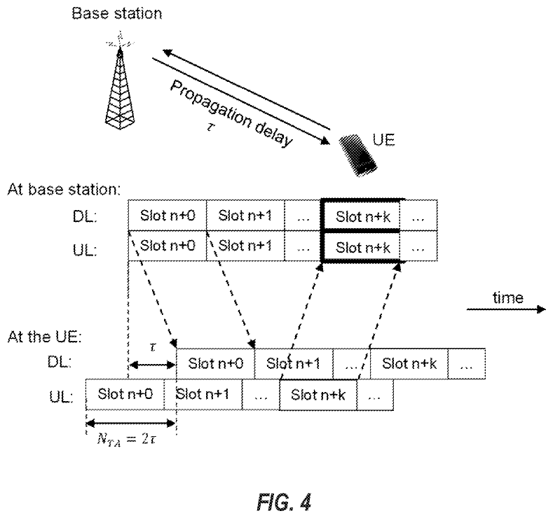

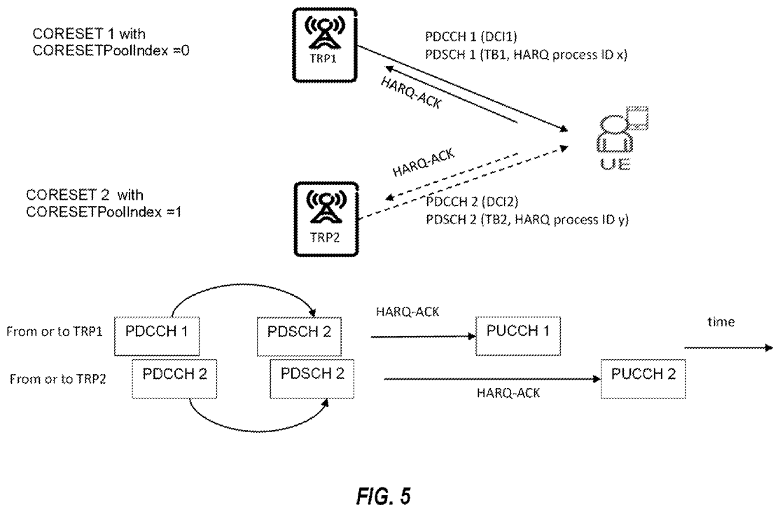

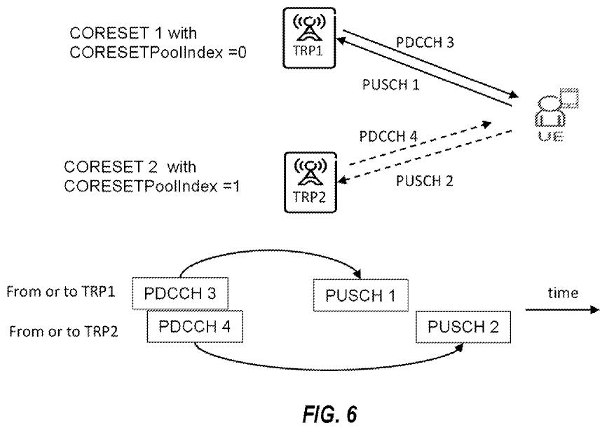

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Embodiments are provided by way of example to convey the scope of the subject matter to those skilled in the art. Additional information may also be found in the document(s) provided in the Appendix.

There currently exist certain challenges. In New Radio (NR) Rel-18, two Timing Advances (TAs), one associated to each Transmission and Reception Point (TRP), are to be supported for multi-Downlink Control Information (DCI) based uplink transmissions towards two TRPs, where a large time difference between the two TRPs may exist. For UL transmissions to different TRPs, different timing advances are applied such that the received UL signals at each intended TRP are time aligned. For this purpose, it has been agreed that a serving cell can be configured with two Timing Advance Groups (TAGs), one associated to each TRP. A separate timing alignment timer is associated to each of the two TAGs.

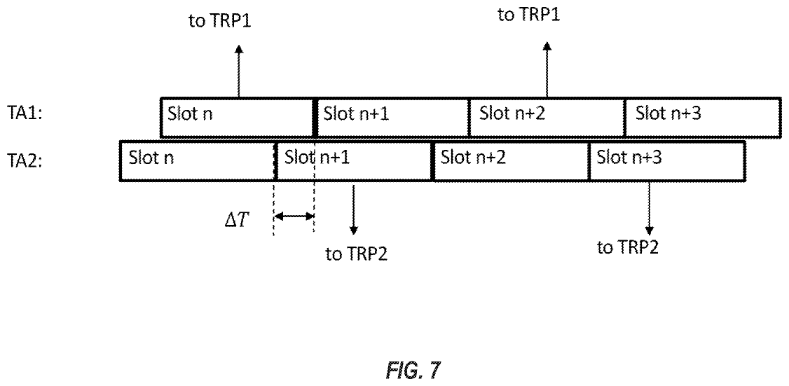

When the two TAs are different, uplink (UL) transmissions to two TRPs can overlap in time. FIG. 7 illustrates an example of possible time overlap of UL transmissions to different TRPs. In the example of FIG. 7, even though UL transmissions to different TRPs are allocated to different logical slots, due to different TAs, the transmissions can overlap. For UEs that can only transmit to one TRP at a time, how to handle this overlap is a problem.

Certain aspects of the disclosure and their embodiments may provide solutions to these or other challenges. Some embodiments of the current disclosure provide methods including one or more of the following steps:
(one or more) TRPs exchange timing advance information configured and signaled to one or more given UE and coordinate to avoid time overlap of UL transmissions.
a UE reports the timing difference between UL transmissions to a first and a second TRP to facilitate TRP coordination for avoiding time overlap of UL transmissions to the two TRPs.
Each of UL channels and signals are allocated with priority level. In case of two overlapping UL transmissions, a UE drops one of the UL transmissions in the overlap time region if
   the UL transmission has a lower priority, or
   the UL transmission starts later in time if the overlapping UL transmissions have the same priority
UL transmissions to one TRP is assigned with higher priority. In case of two overlapping UL transmissions, a UE drops the UL transmissions in the overlap time region to TRP with a lower priority.
A combination of the above.

Communication systems and devices adapted to perform one or a combination of these functions are also provided, according to some embodiments of the current disclosure.

Some embodiments of the disclosure provide a method in a wireless device for performing UL transmission with two UL timing advances in a serving cell, the method including one or more of: receiving a request for a first UL transmission according to a first timing advance; receiving a request for a second UL transmission according to a second timing advance; dropping at least part of the first or second UL transmission in a time duration according to a predefined rule, wherein the first and second UL transmissions overlap in the time duration.

In some embodiments, the method further includes assigning a priority to each UL channel or signal.

In some embodiments, the method further includes assigning a priority to UL transmissions associated to each of the first and second timing advances.

In some embodiments, the pre-defined rule is one or more of: a) dropping one of the first and second UL transmissions with lower priority in the time duration; b) dropping one of the first and second UL transmissions starting later in time in the time duration if the first and second UL transmissions have a same priority.

In some embodiments, the first and second UL transmission is one or more of: (a) PUSCH transmission; (b) PUCCH transmission; (c) SRS transmission.

Certain embodiments may provide one or more of the following technical advantage(s): The possibility of collision of UL transmissions to multiple TRPs may be reduced and thus the UL resource utilization may be improved. Some embodiments of the disclosure may also allow handling collision when it occurs in a consist and predicable way.

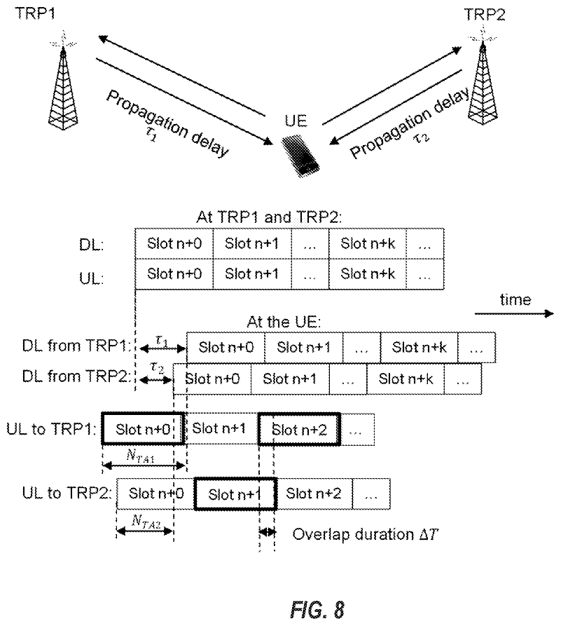

FIG. 8 illustrates UL transmissions to two TRPs with two different timing advances according to some embodiments of the disclosure.

FIG. 8 shows an example of UL time alignment to two TRPs with two time advances, NTA1 and NTA2, within a serving cell. NTA1 and NTA2 are associated to two TAGs, a first TAG and a second TAG, respectively. Note that the two TAGs are applicable within a serving cell. Each of the two TAGs is associated with a respective time alignment timer.

In FIG. 8, it is assumed that the DL and UL slot/symbol timings are aligned at the two TRPs, i.e., N_{TA,offset}=0 for both TRPs. Due to different propagation delays from the two TRPs to a UE, the received DL slot/symbol timings from the two TRPs at the UE are shifted in time. To achieve UL time alignment at each TRP, the UE needs to apply two different timing advances to UL transmissions towards the two TRPs.

In FIG. 8, each of the two timing advances is with respect to the received DL timing from the respective TRP. Alternatively, both of the two timing advances may be with respect to a common DL timing at the UE, e.g., either based on a received DL slot/symbol timing from TRP1 or TRP2.

Note that UL transmission in slot n+2 to TRP1 and UL transmission in slot n+1 to TRP2 partially overlap in time.

In some embodiments, an UL transmission scheduled towards TRP1 is scheduled by a Physical Downlink Control Channel (PDCCH) sent in a Control Resource Set (CORESET) belonging to CORESET Pool index 0. An UL transmission scheduled towards TRP2 is scheduled by a PDCCH sent in a CORESET belonging to CORESET Pool index 1.

In some embodiments, UL transmissions configured towards TRP1 are associated with CORESET Pool index 0. UL transmissions configured towards TRP2 are associated with CORESET Pool index 1.

FIG. 8 illustrates exemplary UL transmissions to two TRPs with two different timing advances according to some embodiments of the disclosure.

### gNB Centric Embodiments

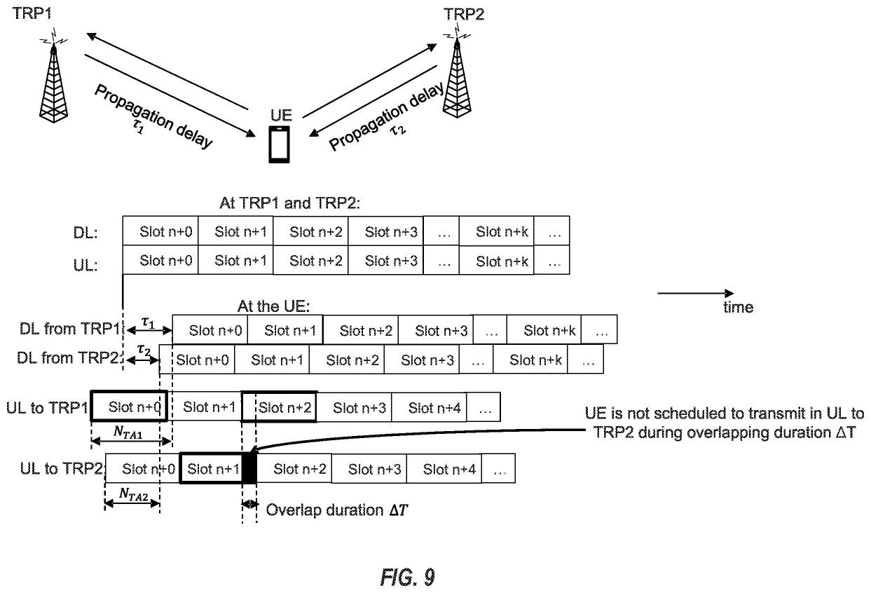

If both TRPs know ΔT, then proper action can be taken by the two TRPs in coordination to avoid scheduling UL transmissions to both TRPs in the overlapping time area. Note that, as illustrated in FIG. 8 as an example, ΔT refers to the overlap duration of the overlap between an UL transmission from the UE to TRP1 (e.g., in slot n+2 in the example of FIG. 8) and an UL transmission from the UE to TRP2 (e.g., slot n+1 in the example of FIG. 8). For example,
one TRP does not schedule in the overlapping duration while the other TRP can schedule in the overlapping time. An example is illustrated in FIG. 9, where the network does not schedule the UE to transmit any UL transmission to TRP2 in the overlapping region.
In another example embodiment, UL transmission is not scheduled towards each TRP in alternating slots. An example is shown in FIG. 10. As shown in the figure,
   in Slot n+1, UL transmission is not scheduled towards TRP2 in the overlapping duration;
   in Slot n+2, UL transmission is not scheduled towards TRP1 in the overlapping duration;
   in Slot n+3, UL transmission is not scheduled towards TRP2 in the overlapping duration;
   and the alternating pattern continues.
the overlapping duration is split into two parts; UL transmission to the first TRP is not scheduled during the first part of the overlapping duration, and UL transmission to the second TRP is not scheduled during the second part of the overlapping duration. In some embodiments, the first and the second part are of equal duration. In some other embodiments, the first and the second parts may be of non-equal duration. In some embodiments, the duration of the first and second parts are exchanged between TRPs so that each TRP knows in which part among the two overlapping parts the UE is allowed to be scheduled for UL transmission to the respective TRPs . . . both TRP do not schedule in the overlapping time

FIG. 9 illustrates an example of UL transmission restricted towards one of the TRPs during the overlapping duration ΔT according to some embodiments of the disclosure.

FIG. 10 illustrates an example of UL transmission restricted towards different TRPs during the overlapping duration ΔT in alternating slots according to some embodiments of the disclosure.

To obtain ΔT at both TRPs:
Embodiment 1: Exchange TA between TRPs, including N_{TA,offset} if it is configured differently between the two TRPs. Note that TRP1 sends information regarding NTA1 to the UE and TRP2 sends information regarding NTA2 to the UE. In order to obtain ΔT at both TRPs, TRP1 sends NTA1 to TRP2, and TRP2 sends NTA2 to TRP1. Note that in some embodiments, TRP1 sends NTA1 to TRP2 only when there is an update to NTA1. Likewise, TRP2 sends NTA2 to TRP1 only when there is an update to NTA2.

Embodiment 2: UE reports ΔT to both TRPs. In some embodiments, the UE only reports ΔT=N_{TA}1−N_{TA2} to the TRPs only when one of or both N_{TA1} and N_{TA2} is updated. In another embodiment, UE reports ΔT only when it is requested.

### UE Centric Embodiments

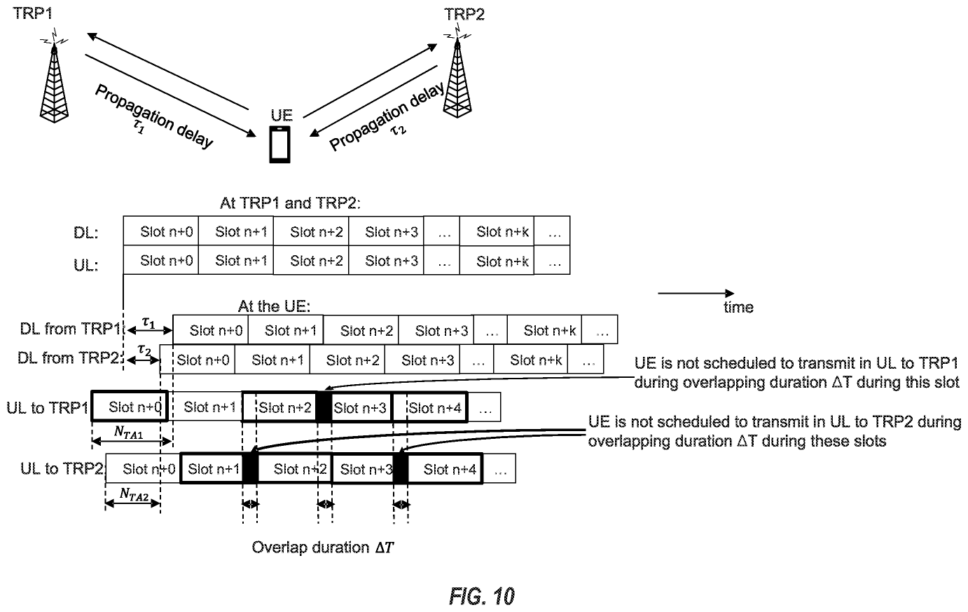

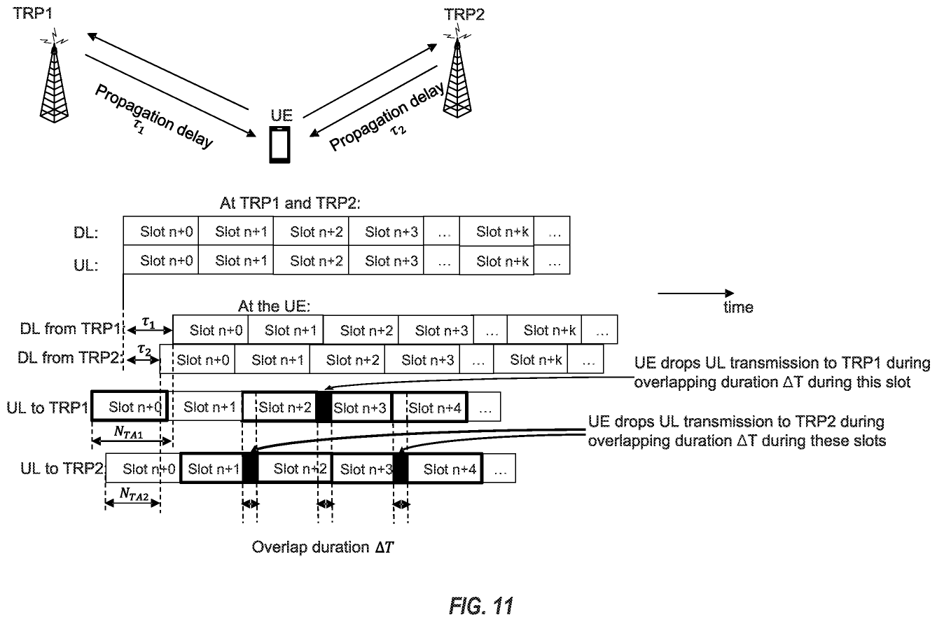

In case that there is an overlap of two UL transmissions to the two TRPs, the following actions may be taken by the UE.
UE may drop part of a UL transmission starting later in time in the overlapping time, i.e., the part that overlaps in time with an ongoing UL transmission is not transmitted.
UE may drop the UL transmission starting later in time when it would overlap with an ongoing UL transmission
In another embodiment, the UE alternates between slots whether it drops an UL transmission starting later in time or it drops an UL transmission starting earlier in time during the overlapping duration. An example is shown in FIG. 11, where
   in Slot n+1, UL transmission towards TRP2 in the overlapping duration is dropped by the UE;
   in Slot n+2, UL transmission towards TRP1 in the overlapping duration is dropped by the UE;
   in Slot n+3, UL transmission towards TRP2 in the overlapping duration is dropped by the UE;
   and the alternating pattern continues.
In another embodiment, the overlapping duration is split into two parts; UL transmission to the first TRP is dropped during the first part of the overlapping duration, and UL transmission to the second TRP is dropped during the second part of the overlapping duration. In some embodiments, the first and the second part are of equal duration. In some other embodiments, the first and the second parts may be of non-equal duration. In some embodiments, the duration of the first and second parts of the overlapping duration may be signaled to the UE by the network.
In another embodiment, which UL transmission the UE shall drop in the overlap time duration depends on what channel or reference signal is being transmitted in the uplink during the overlapping region. Different UL channels and signals may be assigned with different priority levels for the purpose, and in case that two channels/signals overlap in time, the channel or signal with a lower priority is dropped in the overlap time duration. Some examples are provided below:
   if UE is scheduled a PUCCH carrying Hybrid Automatic Repeat Request (HARQ) Acknowledgement (ACK)/Negative Acknowledgement (NACK) and/or other Uplink Control Information (UCI) such as Channel State Information (CSI) or Scheduling Request (SR) to TRP1, and the UE is triggered to transmit an SRS to TRP2, then the UE drops the SRS transmission to TRP2 in the overlapping region;
   if UE is scheduled a PUSCH carrying data and/or other UCI such as HARQ ACK/NACK or CSI to TRP1, and the UE is triggered to transmit an SRS to TRP2, then the UE drops the SRS transmission to TRP2 in the overlapping region;
   if UE is scheduled a PUSCH carrying data to TRP1, and the UE is triggered to transmit a PUCCH carrying HARQ ACK/NACK to TRP2, then the UE drops PUSCH carrying data in the overlapping region.
   if UE is scheduled a PUCCH with higher priority carrying HARQ ACK/NACK and/or other UCI such as CSI or SR to TRP1, and UE is scheduled a PUCCH with lower priority carrying HARQ ACK/NACK and/or other UCI such as CSI or SR to TRP2, then the UE drops the lower priority UL transmission to TRP2 in the overlapping region;
   if UE is scheduled a PUSCH with higher priority carrying data and/or other UCI such as HARQ ACK/NACK or CSI to TRP1, and UE is scheduled a PUSCH with lower priority carrying data and/or other UCI such as HARQ ACK/NACK or CSI to TRP2, then the UE drops the lower priority UL transmission to TRP2 in the overlapping region.
In another embodiment, UL transmissions to one TRP is assigned with higher priority than UL transmissions to the other TRP. In case of two overlapping UL transmissions, UE drops the UL transmissions in the overlap time region to the TRP with a lower priority
   In some scenario, the priority for UL transmission to the two TRPs may be determined by the UE based on some predefined rules such as pathloss or Tx power.

FIG. 11 illustrates an example of UE dropping UL transmission towards different TRPs during the overlapping duration ΔT in alternating slots according to some embodiments of the disclosure.

In some embodiments, a combination of the gNB centric and UE centric approaches may be used so that any remaining overlap can be handled by the UE centric approach. In another embodiment, an extra guard period is inserted before and/or after each overlapping duration ΔT. This could for example mean that one or more Orthogonal Frequency Division Multiplexing (OFDM) symbols, before and/or after the overlapping duration ΔT, is used as guard period and can therefore not be used for scheduling. This could for example be useful in case the UE needs to switch UE antennas or UE panels when switching the transmission from one TRP to another TRP and where the UE antenna or UE panel switch is associated with a certain time delay. This embodiment can be associated or combined with any of the previous embodiments.

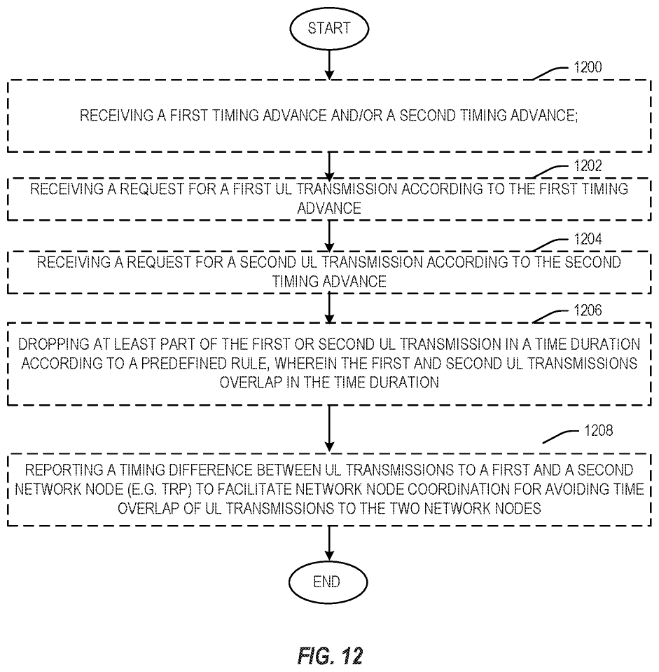

FIG. 12 illustrates a method performed by a UE according to some embodiments of the disclosure. The method includes one or more of: receiving (step 1200) a first timing advance and/or a second timing advance; receiving (step 1202) a request for a first UL transmission according to the first timing advance; receiving (step 1204) a request for a second UL transmission according to the second timing advance; dropping (step 1206) at least part of the first or second UL transmission in a time duration according to a predefined rule, wherein the first and second UL transmissions overlap in the time duration; and/or reporting (step 1208) a timing difference between UL transmissions to a first and a second network node (e.g. TRP) to facilitate network node coordination for avoiding time overlap of UL transmissions to the two network nodes. The steps may be performed in any combination and in any order.

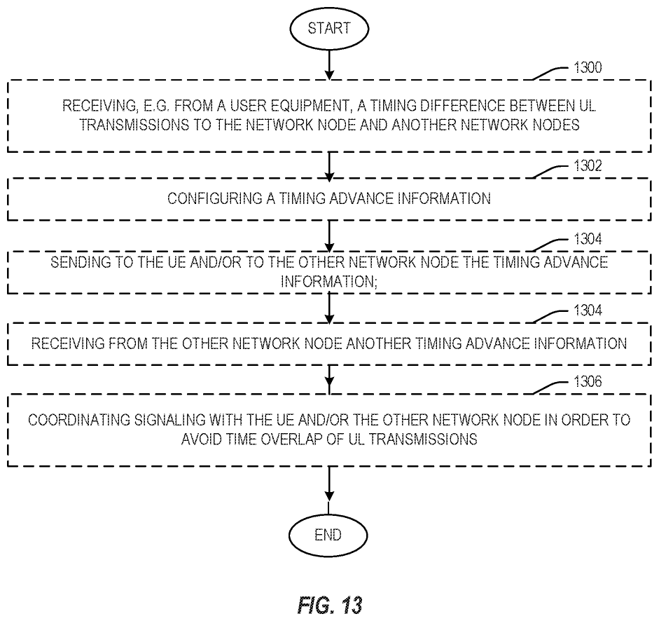

FIG. 13 illustrates a method performed by a network node according to some embodiments of the disclosure. The method includes one or more of: receiving (step 1300), e.g. from a user equipment, a timing difference between UL transmissions to the network node and another network nodes; configuring (step 1302) a timing advance information; sending (step 1304) to the UE and/or to the other network node the timing advance information; receiving (step 1306) from the other network node another timing advance information; and/or coordinating (step 1308) signaling with the UE and/or the other network node in order to avoid time overlap of UL transmissions. The steps may be performed in any combination and in any order. As discussed above, this coordination may include coordinated uplink scheduling performed such overlap between uplink transmissions from the UE to different TRPs as part of a multi-DCI based multi-TRP uplink transmission is avoided.

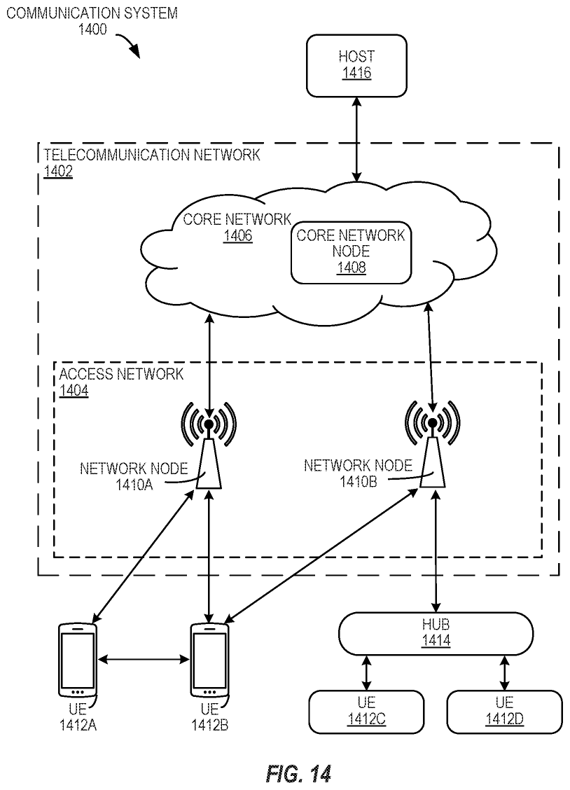

FIG. 14 shows an example of a communication system 1400 in accordance with some embodiments.

In the example, the communication system 1400 includes a telecommunication network 1402 that includes an access network 1404, such as a Radio Access Network (RAN), and a core network 1406, which includes one or more core network nodes 1408. The access network 1404 includes one or more access network nodes, such as network nodes 1410A and 1410B (one or more of which may be generally referred to as network nodes 1410), or any other similar Third Generation Partnership Project (3GPP) access node or non-3GPP Access Point (AP). The network nodes 1410 facilitate direct or indirect connection of User Equipment (UE), such as by connecting UEs 1412A, 1412B, 1412C, and 1412D (one or more of which may be generally referred to as UEs 1412) to the core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The UEs 1412 may be any of a wide variety of communication devices, including wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402 and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 14 enables connectivity between the UEs, network nodes, and hosts. In that sense, the communication system 1400 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1402 is a cellular network that implements 3GPP standardized features. Accordingly, the telecommunication network 1402 may support network slicing to provide different logical networks to different devices that are connected to the telecommunication network 1402. For example, the telecommunication network 1402 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 1414 communicates with the access network 1404 to facilitate indirect communication between one or more UEs (e.g., UE 1412C and/or 1412D) and network nodes (e.g., network node 1410B). In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a Virtual Reality (VR) headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistent or intermittent connection to the network node 1410B. The hub 1414 may also allow for a different communication scheme and/or schedule between the hub 1414 and UEs (e.g., UE 1412C and/or 1412D), and between the hub 1414 and the core network 1406. In other examples, the hub 1414 is connected to the core network 1406 and/or one or more UEs via a wired connection. Moreover, the hub 1414 may be configured to connect to a Machine-to-Machine (M2M) service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410B. In other embodiments, the hub 1414 may be a non-dedicated hub—that is, a device which is capable of operating to route communications between the UEs and the network node 1410B, but which is additionally capable of operating as a communication start and/or end point for certain data channels.

FIG. 15 shows a UE 1500 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V21), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1500 includes processing circuitry 1502 that is operatively coupled via a bus 1504 to an input/output interface 1506, a power source 1508, memory 1510, a communication interface 1512, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry 1502 is configured to process instructions and data and may be configured to implement any sequential state machine operative to execute instructions stored as machine-readable computer programs in the memory 1510. The processing circuitry 1502 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1502 may include multiple Central Processing Units (CPUs).

In the example, the input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1508 is structured as a battery or battery pack. Other types of power sources, such as an external power source (e.g., an electricity outlet), photovoltaic device, or power cell, may be used. The power source 1508 may further include power circuitry for delivering power from the power source 1508 itself, and/or an external power source, to the various parts of the UE 1500 via input circuitry or an interface such as an electrical power cable. Delivering power may be, for example, for charging the power source 1508. Power circuitry may perform any formatting, converting, or other modification to the power from the power source 1508 to make the power suitable for the respective components of the UE 1500 to which power is supplied.

The memory 1510 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1510 includes one or more application programs 1514, such as an operating system, web browser application, a widget, gadget engine, or other application, and corresponding data 1516. The memory 1510 may store, for use by the UE 1500, any of a variety of various operating systems or combinations of operating systems.

The memory 1510 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1510 may allow the UE 1500 to access instructions, application programs, and the like stored on transitory or non-transitory memory media, to off-load data, or to upload data. An article of manufacture, such as one utilizing a communication system, may be tangibly embodied as or in the memory 1510, which may be or comprise a device-readable storage medium.

The processing circuitry 1502 may be configured to communicate with an access network or other network using the communication interface 1512. The communication interface 1512 may comprise one or more communication subsystems and may include or be communicatively coupled to an antenna 1522. The communication interface 1512 may include one or more transceivers used to communicate, such as by communicating with one or more remote transceivers of another device capable of wireless communication (e.g., another UE or a network node in an access network). Each transceiver may include a transmitter 1518 and/or a receiver 1520 appropriate to provide network communications (e.g., optical, electrical, frequency allocations, and so forth). Moreover, the transmitter 1518 and receiver 1520 may be coupled to one or more antennas (e.g., the antenna 1522) and may share circuit components, software, or firmware, or alternatively be implemented separately.

In the illustrated embodiment, communication functions of the communication interface 1512 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1512, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1500 shown in FIG. 15.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

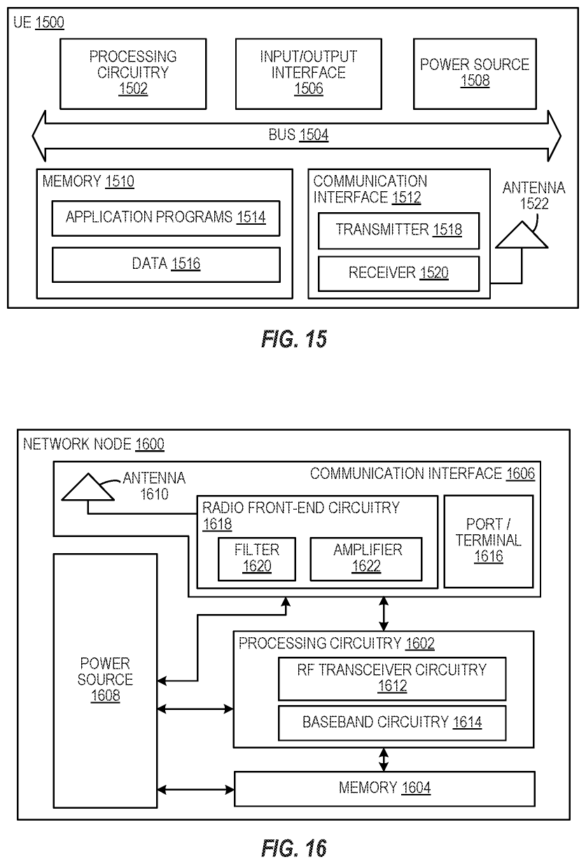

FIG. 16 shows a network node 1600 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS). Each base station QQ102 includes one or more Transmission Points (or Transmission Reception Points) (TRPs) (not shown). Also, in case of multi-TRP transmission, one of the TRPs may be another base station, e.g., data are transmitted from 2 base stations to a UE (under control of one of the base stations through base station coordination).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

In some embodiments, a TRP (Transmission/Reception Point or Transmission Point): may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple Transmit/Receive Point (multi-TRP) operation, a serving cell can schedule UE from two TRPs, providing better PDSCH coverage, reliability and/or data rates. There are two different operation modes for multi-TRP: single-DCI and multi-DCI. For both modes, control of uplink and downlink operation is done by both physical layer and MAC. In single-DCI mode, UE is scheduled by the same DCI for both TRPs and in multi-DCI mode, UE is scheduled by independent DCIs from each TRP.

The network node 1600 includes processing circuitry 1602, memory 1604, a communication interface 1606, and a power source 1608. The network node 1600 may be composed of multiple physically separate components (e.g., a Node B component and an RNC component, or a BTS component and a BSC component, etc.), which may each have their own respective components. In certain scenarios in which the network node 1600 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1600 may be configured to support multiple RATs. In such embodiments, some components may be duplicated (e.g., separate memory 1604 for different RATs) and some components may be reused (e.g., an antenna 1610 may be shared by different RATs). The network node 1600 may also include multiple sets of the various illustrated components for different wireless technologies integrated into network node 1600, for example GSM, WCDMA, LTE, NR. WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1600.

The processing circuitry 1602 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1600 components, such as the memory 1604, to provide network node 1600 functionality.

In some embodiments, the processing circuitry 1602 includes a System on a Chip (SOC). In some embodiments, the processing circuitry 1602 includes one or more of Radio Frequency (RF) transceiver circuitry 1612 and baseband processing circuitry 1614. In some embodiments, the RF transceiver circuitry 1612 and the baseband processing circuitry 1614 may be on separate chips (or sets of chips), boards, or units, such as radio units and digital units. In alternative embodiments, part or all of the RF transceiver circuitry 1612 and the baseband processing circuitry 1614 may be on the same chip or set of chips, boards, or units.

The memory 1604 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions capable of being executed by the processing circuitry 1602 and utilized by the network node 1600. The memory 1604 may be used to store any calculations made by the processing circuitry 1602 and/or any data received via the communication interface 1606. In some embodiments, the processing circuitry 1602 and the memory 1604 are integrated.

The communication interface 1606 is used in wired or wireless communication of signaling and/or data between a network node, access network, and/or UE. As illustrated, the communication interface 1606 comprises port(s)/terminal(s) 1616 to send and receive data, for example to and from a network over a wired connection. The communication interface 1606 also includes radio front-end circuitry 1618 that may be coupled to, or in certain embodiments a part of, the antenna 1610. The radio front-end circuitry 1618 comprises filters 1620 and amplifiers 1622. The radio front-end circuitry 1618 may be connected to the antenna 1610 and the processing circuitry 1602. The radio front-end circuitry 1618 may be configured to condition signals communicated between the antenna 1610 and the processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of the filters 1620 and/or the amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface 1606 may comprise different components and/or different combinations of components.

In certain alternative embodiments, the network node 1600 does not include separate radio front-end circuitry 1618; instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes the one or more ports or terminals 1616, the radio front-end circuitry 1618, and the RF transceiver circuitry 1612 as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the network node 1600 and connectable to the network node 1600 through an interface or port.

The antenna 1610, the communication interface 1606, and/or the processing circuitry 1602 may be configured to perform any receiving operations and/or certain obtaining operations described herein as being performed by the network node 1600. Any information, data, and/or signals may be received from a UE, another network node, and/or any other network equipment. Similarly, the antenna 1610, the communication interface 1606, and/or the processing circuitry 1602 may be configured to perform any transmitting operations described herein as being performed by the network node 1600. Any information, data, and/or signals may be transmitted to a UE, another network node, and/or any other network equipment.

The power source 1608 provides power to the various components of the network node 1600 in a form suitable for the respective components (e.g., at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g., the power grid or an electricity outlet) via input circuitry or an interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 16 for providing certain aspects of the network node's functionality, including any of the functionality described herein and/or any functionality necessary to support the subject matter described herein. For example, the network node 1600 may include user interface equipment to allow input of information into the network node 1600 and to allow output of information from the network node 1600. This may allow a user to perform diagnostic, maintenance, repair, and other administrative functions for the network node 1600.

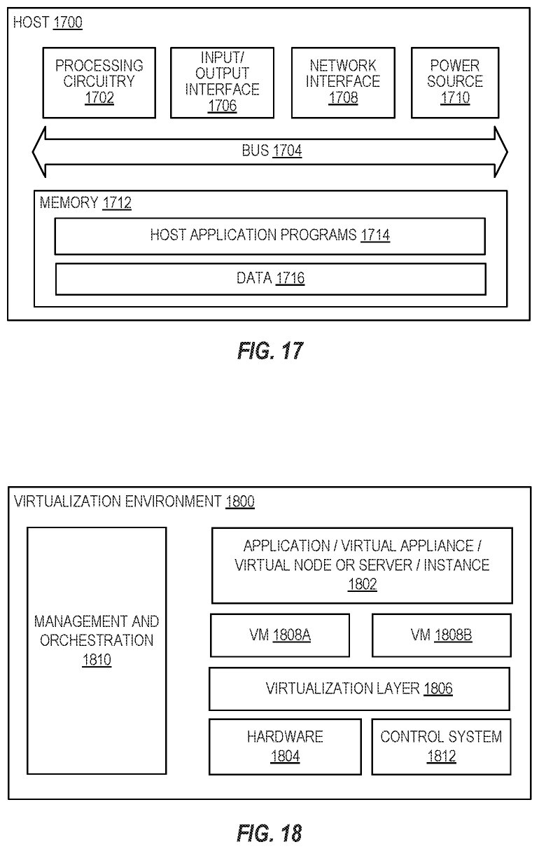

FIG. 17 is a block diagram of a host 1700, which may be an embodiment of the host 1416 of FIG. 14, in accordance with various aspects described herein. As used herein, the host 1700 may be or comprise various combinations of hardware and/or software including a standalone server, a blade server, a cloud-implemented server, a distributed server, a virtual machine, container, or processing resources in a server farm. The host 1700 may provide one or more services to one or more UEs.

The host 1700 includes processing circuitry 1702 that is operatively coupled via a bus 1704 to an input/output interface 1706, a network interface 1708, a power source 1710, and memory 1712. Other components may be included in other embodiments. Features of these components may be substantially similar to those described with respect to the devices of previous figures, such as FIGS. 15 and 16, such that the descriptions thereof are generally applicable to the corresponding components of the host 1700.

The memory 1712 may include one or more computer programs including one or more host application programs 1714 and data 1716, which may include user data, e.g., data generated by a UE for the host 1700 or data generated by the host 1700 for a UE. Embodiments of the host 1700 may utilize only a subset or all of the components shown. The host application programs 1714 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1714 may also provide for user authentication and licensing checks and may periodically report health, routes, and content availability to a central node, such as a device in or on the edge of a core network. Accordingly, the host 1700 may select and/or indicate a different host for Over-The-Top (OTT) services for a UE. The host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1802 (which may alternatively be called software instances, virtual appliances, network functions, virtual nodes, virtual network functions, etc.) are run in the virtualization environment 1700 to implement some of the features, functions, and/or benefits of some of the embodiments disclosed herein.

Hardware 1804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1806 (also referred to as hypervisors or VM Monitors (VMMs)), provide VMs 1808A and 1808B (one or more of which may be generally referred to as VMs 1808), and/or perform any of the functions, features, and/or benefits described in relation with some embodiments described herein. The virtualization layer 1806 may present a virtual operating platform that appears like networking hardware to the VMs 1808.

The VMs 1808 comprise virtual processing, virtual memory, virtual networking, or interface and virtual storage, and may be run by a corresponding virtualization layer 1806. Different embodiments of the instance of a virtual appliance 1802 may be implemented on one or more of the VMs 1808, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1808 may be a software implementation of a physical machine that runs programs as if they were executing on a physical, non-virtualized machine. Each of the VMs 1808, and that part of the hardware 1804 that executes that VM, be it hardware dedicated to that VM and/or hardware shared by that VM with others of the VMs 1808, forms separate virtual network elements. Still in the context of NFV, a virtual network function is responsible for handling specific network functions that run in one or more VMs 1808 on top of the hardware 1804 and corresponds to the application 1802.

The hardware 1804 may be implemented in a standalone network node with generic or specific components. The hardware 1804 may implement some functions via virtualization. Alternatively, the hardware 1804 may be part of a larger cluster of hardware (e.g., such as in a data center or CPE) where many hardware nodes work together and are managed via management and orchestration 1810, which, among others, oversees lifecycle management of the applications 1802. In some embodiments, the hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1812 which may alternatively be used for communication between hardware nodes and radio units.

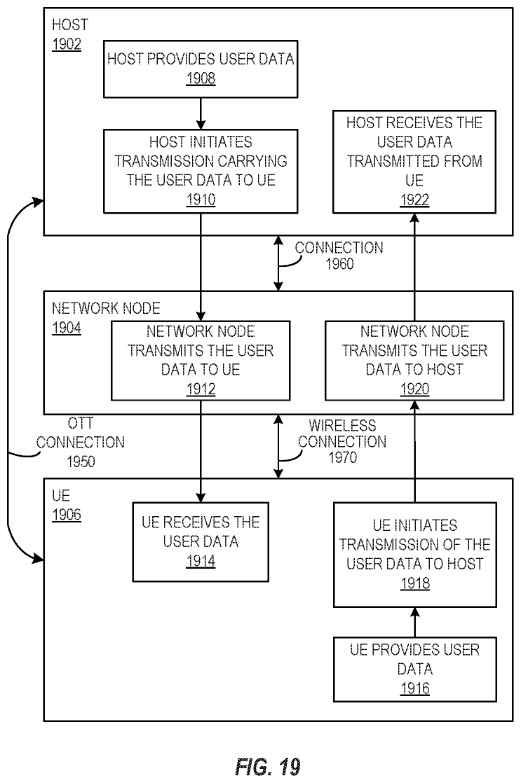

FIG. 19 shows a communication diagram of a host 1902 communicating via a network node 1904 with a UE 1906 over a partially wireless connection in accordance with some embodiments. Example implementations, in accordance with various embodiments, of the UE (such as the UE 1412A of FIG. 14 and/or the UE 1500 of FIG. 15), the network node (such as the network node 1410A of FIG. 14 and/or the network node 1600 of FIG. 16), and the host (such as the host 1416 of FIG. 14 and/or the host 1700 of FIG. 17) discussed in the preceding paragraphs will now be described with reference to FIG. 19.

Like the host 1700, embodiments of the host 1902 include hardware, such as a communication interface, processing circuitry, and memory. The host 1902 also includes software, which is stored in or is accessible by the host 1902 and executable by the processing circuitry. The software includes a host application that may be operable to provide a service to a remote user, such as the UE 1906 connecting via an OTT connection 1950 extending between the UE 1906 and the host 1902. In providing the service to the remote user, a host application may provide user data which is transmitted using the OTT connection 1950.

The network node 1904 includes hardware enabling it to communicate with the host 1902 and the UE 1906 via a connection 1960. The connection 1960 may be direct or pass through a core network (like the core network 1406 of FIG. 14) and/or one or more other intermediate networks, such as one or more public, private, or hosted networks. For example, an intermediate network may be a backbone network or the Internet.

The UE 1906 includes hardware and software, which is stored in or accessible by the UE 1906 and executable by the UE's processing circuitry. The software includes a client application, such as a web browser or operator-specific “app” that may be operable to provide a service to a human or non-human user via the UE 1906 with the support of the host 1902. In the host 1902, an executing host application may communicate with the executing client application via the OTT connection 1950 terminating at the UE 1906 and the host 1902. In providing the service to the user, the UE's client application may receive request data from the host's host application and provide user data in response to the request data. The OTT connection 1950 may transfer both the request data and the user data. The UE's client application may interact with the user to generate the user data that it provides to the host application through the OTT connection 1950.

The OTT connection 1950 may extend via the connection 1960 between the host 1902 and the network node 1904 and via a wireless connection 1970 between the network node 1904 and the UE 1906 to provide the connection between the host 1902 and the UE 1906. The connection 1960 and the wireless connection 1970, over which the OTT connection 1950 may be provided, have been drawn abstractly to illustrate the communication between the host 1902 and the UE 1906 via the network node 1904, without explicit reference to any intermediary devices and the precise routing of messages via these devices.

As an example of transmitting data via the OTT connection 1950, in step 1908, the host 1902 provides user data, which may be performed by executing a host application. In some embodiments, the user data is associated with a particular human user interacting with the UE 1906. In other embodiments, the user data is associated with a UE 1906 that shares data with the host 1902 without explicit human interaction. In step 1910, the host 1902 initiates a transmission carrying the user data towards the UE 1906. The host 1902 may initiate the transmission responsive to a request transmitted by the UE 1906. The request may be caused by human interaction with the UE 1906 or by operation of the client application executing on the UE 1906. The transmission may pass via the network node 1904 in accordance with the teachings of the embodiments described throughout this disclosure. Accordingly, in step 1912, the network node 1904 transmits to the UE 1906 the user data that was carried in the transmission that the host 1902 initiated, in accordance with the teachings of the embodiments described throughout this disclosure. In step 1914, the UE 1906 receives the user data carried in the transmission, which may be performed by a client application executed on the UE 1906 associated with the host application executed by the host 1902.

In some examples, the UE 1906 executes a client application which provides user data to the host 1902. The user data may be provided in reaction or response to the data received from the host 1902. Accordingly, in step 1916, the UE 1906 may provide user data, which may be performed by executing the client application. In providing the user data, the client application may further consider user input received from the user via an input/output interface of the UE 1906. Regardless of the specific manner in which the user data was provided, the UE 1906 initiates, in step 1918, transmission of the user data towards the host 1902 via the network node 1904. In step 1920, in accordance with the teachings of the embodiments described throughout this disclosure, the network node 1904 receives user data from the UE 1906 and initiates transmission of the received user data towards the host 1902. In step 1922, the host 1902 receives the user data carried in the transmission initiated by the UE 1906.

One or more of the various embodiments improve the performance of OTT services provided to the UE 1906 using the OTT connection 1950, in which the wireless connection 1970 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1902. As another example, the host 1902 may process audio and video data which may have been retrieved from a UE for use in creating maps. As another example, the host 1902 may collect and analyze real-time data to assist in controlling vehicle congestion (e.g., controlling traffic lights). As another example, the host 1902 may store surveillance video uploaded by a UE. As another example, the host 1902 may store or control access to media content such as video, audio, VR, or ΔR which it can broadcast, multicast, or unicast to UEs. As other examples, the host 1902 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1950 between the host 1902 and the UE 1906 in response to variations in the measurement results. The measurement procedure and/or the network functionality for reconfiguring the OTT connection 1950 may be implemented in software and hardware of the host 1902 and/or the UE 1906. In some embodiments, sensors (not shown) may be deployed in or in association with other devices through which the OTT connection 1950 passes; the sensors may participate in the measurement procedure by supplying values of the monitored quantities exemplified above, or by supplying values of other physical quantities from which software may compute or estimate the monitored quantities. The reconfiguring of the OTT connection 1950 may include message format, retransmission settings, preferred routing, etc.; the reconfiguring need not directly alter the operation of the network node 1904. Such procedures and functionalities may be known and practiced in the art. In certain embodiments, measurements may involve proprietary UE signaling that facilitates measurements of throughput, propagation times, latency, and the like by the host 1902. The measurements may be implemented in that software causes messages to be transmitted, in particular empty or ‘dummy’ messages, using the OTT connection 1950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole and/or by end users and a wireless network generally.

Some example embodiments of the present disclosure are as follows:

### Group A Embodiments

Embodiment 1: A method performed by a user equipment, UE, the method comprising one or more of:
a) receiving a first timing advance and/or a second timing advance;
b) receiving a request for a first UL transmission according to the first timing advance;
c) receiving a request for a second UL transmission according to the second timing advance;
d) dropping at least part of the first or second UL transmission in a time duration according to a predefined rule, wherein the first and second UL transmissions overlap in the time duration; and/or
e) reporting a timing difference between UL transmissions to a first and a second network node (e.g., TRP) to facilitate network node coordination for avoiding time overlap of UL transmissions to the two network nodes.

Embodiment 2: The method of the previous embodiment further comprising assigning a priority to a plurality of UL channels and/or signals.

Embodiment 3: The method of any of the previous embodiments further comprising assigning a priority to UL transmissions associated to each of the first and second timing advances.

Embodiment 4: The method of any of the previous embodiments where the pre-defined rule is one or more of
a) dropping one of the first and second UL transmissions with lower priority in the time duration
b) dropping one of the first and second UL transmissions starting later in time in the time duration if the first and second UL transmissions have a same priority.

Embodiment 5: The method of any of the previous embodiments wherein first and second UL transmission are one or more of:
a) a PUSCH transmission
b) a PUCCH transmission
c) an SRS transmission

Embodiment 6: The method of any of the previous embodiments wherein the priority of UL transmissions to a TRP may be determined by the UE based on factors such as receive reference signal level, pathloss, or transmit power.

Embodiment 7: The method of any of the previous embodiments, further comprising: providing user data; and forwarding the user data to a host via the transmission to the network node.

### Group B Embodiments

Embodiment 8: A method performed by a network node (e.g., a TRP), the method comprising one or more of:
receiving, e.g. from a user equipment, a timing difference between UL transmissions to the network node and another network nodes;
configuring a timing advance information;
sending to the UE and/or to the other network node the timing advance information;
receiving from the other network node another timing advance information; and/or
coordinating signaling with the UE and/or the other network node in order to avoid time overlap of UL transmissions.

Embodiment 9: The method of the previous embodiment including any of the features of Group A Embodiments.

Embodiment 10: The method of any of the previous embodiments, further comprising: obtaining user data; and forwarding the user data to a host or a user equipment.

### Group C Embodiments

Embodiment 11: A user equipment, comprising: processing circuitry configured to perform any of the steps of any of the Group A embodiments; and power supply circuitry configured to supply power to the processing circuitry.

Embodiment 12: A network node, the network node comprising: processing circuitry configured to perform any of the steps of any of the Group B embodiments; and power supply circuitry configured to supply power to the processing circuitry.

Embodiment 13: A user equipment (UE), the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 14: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 15: The host of the previous embodiment, wherein the cellular network further includes a network node configured to communicate with the UE to transmit the user data to the UE from the host.

Embodiment 16: The host of the previous 2 embodiments, wherein: the processing circuitry of the host is configured to execute a host application, thereby providing the user data; and the host application is configured to interact with a client application executing on the UE, the client application being associated with the host application.

Embodiment 17: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 18: The method of the previous embodiment, further comprising: at the host, executing a host application associated with a client application executing on the UE to receive the user data from the UE.

Embodiment 19: The method of the previous embodiment, further comprising: at the host, transmitting input data to the client application executing on the UE, the input data being provided by executing the host application, wherein the user data is provided by the client application in response to the input data from the host application.

Embodiment 20: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 21: The host of the previous embodiment, wherein the cellular network further includes a network node configured to communicate with the UE to transmit the user data from the UE to the host.

Embodiment 22: The host of the previous 2 embodiments, wherein: the processing circuitry of the host is configured to execute a host application, thereby providing the user data; and the host application is configured to interact with a client application executing on the UE, the client application being associated with the host application.

Embodiment 23: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 24: The method of the previous embodiment, further comprising: at the host, executing a host application associated with a client application executing on the UE to receive the user data from the UE.

Embodiment 25: The method of the previous embodiment, further comprising: at the host, transmitting input data to the client application executing on the UE, the input data being provided by executing the host application, wherein the user data is provided by the client application in response to the input data from the host application.

Embodiment 26: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 27: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 28: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 29: The method of the previous embodiment, further comprising, at the network node, transmitting the user data provided by the host for the UE.

Embodiment 30: The method of any of the previous 2 embodiments, wherein the user data is provided at the host by executing a host application that interacts with a client application executing on the UE, the client application being associated with the host application.

Embodiment 31: A communication system configured to provide an over-the-top service, the communication system comprising a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 32: The communication system of the previous embodiment, further comprising: the network node; and/or the user equipment.

Embodiment 33: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 34: The host of the previous 2 embodiments, wherein: the processing circuitry of the host is configured to execute a host application, thereby providing the user data; and the host application is configured to interact with a client application executing on the UE, the client application being associated with the host application.

Embodiment 35: The host of the any of the previous 2 embodiments, wherein the initiating receipt of the user data comprises requesting the user data.

Embodiment 36: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 37: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a user equipment (UE), the method comprising:
receiving a first timing advance and a second timing advance;
receiving a request for a first uplink transmission according to the first timing advance;
receiving a request for a second uplink transmission according to the second timing advance, wherein the first uplink transmission and the second uplink transmission at least partially overlap in time; and
dropping at least part of the first uplink transmission or at least part of the second uplink transmission.

2. The method of claim 1, wherein the first uplink transmission and the second uplink transmission are part of a multi-Transmission and Reception Point (TRP) uplink transmission.

3. The method of claim 2, wherein:
the request for the first uplink transmission is a first Downlink Control Information (DCI) carried by a first Physical Downlink Control Channel (PDCCH) in a first Control Resource Set (CORESET; and
the request for the second uplink transmission is a second DCI carried by a second PDCCH in a second CORESET.

4. The method of claim 3, wherein the first CORESET is associated to a first CORESET pool index value and the second CORESET is associated to a second CORESET pool index value, wherein the first and the second CORESET pool index values are different.

5. The method of a claim 1, wherein the first timing advance is associated to a first Timing Advance Group (TAG) and the second timing advance is associated to a second TAG.

6. The method of claim 1, wherein the first uplink transmission is in a first time slot, and the second transmission is in a second time slot that is adjacent in time to the first time slot.

7. The method of claim 6, wherein the first uplink transmission and the second uplink transmission at least partially overlap in time as a result of the first timing advance and the second timing advance.

8. The method of claim 7, wherein the first timing advance is different than the second timing advance.

9.-14. (canceled)

15. The method of claim 1, wherein first and second uplink transmissions are one or more of:
a Physical Uplink Shared Channel (PUSCH) transmission;
a Physical Uplink Control Channel (PUCCH) transmission; and
a Sounding Reference Signal (SRS) transmission.

16. A user equipment (UE) adapted to:
receive a first timing advance and a second timing advance;
receive a request for a first uplink transmission according to the first timing advance;
receive a request for a second uplink transmission according to the second timing advance, wherein the first uplink transmission and the second uplink transmission at least partially overlap in time; and
drop at least part of the first uplink transmission or at least part of the second uplink transmission.

17.-26. (canceled)

27. A method performed by network node for scheduling a first uplink transmission from User Equipment (UE) to a first Transmission and Reception Point (TRP) with a first timing advance in a first time slot and a second uplink transmission to a second TRP with a second timing advance in a second time slot, wherein the first and the second slots are adjacent slots, the method comprising:
determining an overlap in time between the first and second uplink transmissions by assuming that each of the first and second transmission were scheduled in a full slot; and
performing uplink scheduling by adjusting at least one of a start and length of at least one of the first and second uplink transmissions such that the overlap, in time, between the first and second uplink transmissions from the UE is avoided.

28. The method of claim 27, wherein performing uplink scheduling comprises refraining to schedule an uplink transmission from the UE to one of the first and second TRPs in a time duration in which the uplink transmission from the UE to the one of the first and second TRPs would overlap an uplink transmission scheduled from the UE to the other of the first and second TRPs.

29.-32. (canceled)

33. A network node for scheduling a first uplink transmission from User Equipment (UE) to a first Transmission and Reception Point (TRP) with a first timing advance in a first time slot and a second uplink transmission to a second TRP with a second timing advance in a second time slot, wherein the first and the second slots are adjacent slots, the network node adapted to:
determine an overlap in time between the first and second uplink transmissions by assuming that each of the first and second transmission were scheduled in a full slot; and
perform uplink scheduling by adjusting at least one of a start and length of at least one of the first and second uplink transmissions such that the overlap, in time, between the first and second uplink transmissions from the UE is avoided.

34. The network node of claim 33, wherein perform uplink scheduling comprises refrain to schedule an uplink transmission from the UE to one of the first and second TRPs in a time duration in which the uplink transmission from the UE to the one of the first and second TRPs would overlap an uplink transmission scheduled from the UE to the other of the first and second TRPs.

35.-36. (canceled)
